(19) United States
(12) Patent Application Publication
(10) Pub. No.: US 2010/0262435 A1
(43) Pub. Date: Oct. 14, 2010

(54) TARGETED HEALTH CARE CONTENT DELIVERY SYSTEM

(75) Inventors: Kary W. Smith, Cedar City, UT (US); Matthew Mark Marriott, Enoch, UT (US)

Correspondence Address: Workman Nydegger;1000 Eagle Gate Tower, 60 East South Temple, Salt Lake City, UT, 84111, US

(73) Assignee: FUSION GLOBAL LLC., Cedar City, UT (US)

(21) Appl. No.: 12/756,613

(22) Filed: Apr. 8, 2010

Related U.S. Application Data
(60) Provisional application No. 61/168,474, filed on Apr. 10, 2009.

(51) Int. Cl. G06Q 50/00; G06Q 30/00; G06F 17/30

(52) U.S. Cl. 705/3; 705/2; 707/769; 707/E17.014; 707/802; 707/E17.044

(57) ABSTRACT

In one example, a method of providing targeted health care content to a patient includes receiving user data specific to the patient. The user data is stored in a user account associated with the patient. Targeted health care content is identified in a content database based on some or all of the user data. The targeted health care content is delivered to the patient.

### CROSS-REFERENCE TO RELATED APPLICATIONS

The present application claims the benefit of and priority to U.S. Provisional Application Ser. No. 61/168,474, filed Apr. 10, 2009 and entitled “TARGETED HEALTH CARE CONTENT DELIVERY SYSTEM,” which application is fully incorporated herein by reference in its entirety.

### BACKGROUND

1. Field of the Invention

Embodiments of the present invention generally relate to content delivery. In particular, some example embodiments relate to delivery of targeted health care content to patients.

2. Related Technology

In this digital age, medical professionals have sophisticated electronic medical records systems, and many medical information websites exist, but the medical profession, in general, has not considered useful ways to use information technology to communicate information to patients.

The office visit today is very similar to the office visit of 20 years ago, with quiet waiting rooms, long wait times, and exam visits with very little time spent interfacing with medical professionals. This can leave patients frustrated because oft times, the medical professional expects the patient to ask questions, but the patient has no knowledge of what questions to even ask and relies on the medical professional to provide adequate information.

Further, medical professionals are under increasing pressure to show productivity, typically opting to spend less and less time with patients, and scheduling as many patients as their schedule will allow. This further exacerbates the frustrating patient experience with medical professionals, unsurprisingly, being rated low on the “customer service” scale.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

In general, example embodiments relate to delivery of targeted health care content to patients.

In one example embodiment, a method of providing targeted content to a patient includes receiving user data specific to the patient. The user data is stored in a user account associated with the patient. Targeted health care content is identified in a content database based on some or all of the user data. The targeted health care content is delivered to the patient.

In another example embodiment, a method of providing health care content to patients includes storing, in a database, health care content relating to one or ore specific health care practice areas. The health care content is tagged with keywords such that the health care content is pluggable into targeted searching capabilities. User data specific to the patient is received that identifies at least one of a medical condition or an interest of the patient. The health care content is searched for targeted health care content targeted to the patient based on the keyword tags relating to the medical condition or the interest of the patient. The targeted health care content is delivered to the patient.

In yet another example embodiment, a targeted health care content delivery system includes a computing device in a distributed network computer system, a content database, and a content selection module. The computing device is for executing computer-executable instructions. The content database is configured to store health care content relating to one or more specific health care practice areas. The content selection module includes computer-executable instructions stored on a physical computer readable medium located in the distributed network computer system that when executed by the computing device identifies targeted health care content in the content database based on user data associated with a patient and delivers the targeted health care content to the patient.

These and other aspects of example embodiments will become more fully apparent from the following description and appended claims.

### BRIEF DESCRIPTION OF THE DRAWINGS

To further clarify various aspects of some embodiments of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example operating environment in which some embodiments can be implemented;

FIG. 2 illustrates a content selection module that can be implemented in the example operating environment of FIG. 1 for identifying and delivering targeted health care content to patients;

FIG. 3 is an example of a chart that can be generated by a charting module included in the content selection module of FIG. 2;

FIGS. 4A and 4B depict aspects of an application map for accessing digital content via one or more client devices of FIG. 1;

FIGS. 5A-5E include screen shots of a first example GUI that can be employed in conjunction with the application map of FIGS. 4A-4B;

FIG. 5F is a screen shot of a second example GUI that can be employed in conjunction with the application map of FIGS. 4A-4B

FIG. 6 is a flow chart of an example method of updating health care content in a local content database in the example operating environment of FIG. 1;

FIG. 7 is a flow chart of an example method of updating a content server in the example operating environment of FIG. 1 from the point of view of an administrator user;

FIG. 8 is a flow chart of an example method of updating a content server in the example operating environment of FIG. 1 from the point of view of a client user;

FIG. 9 is a flow chart of an example method of syncing various components within the example operating environment of FIG. 1; and

FIG. 10 is a flow chart of an example method of providing targeted content to a patient.

### DETAILED DESCRIPTION OF SOME EXAMPLE EMBODIMENTS

Reference will now be made to the drawings to describe various aspects of exemplary embodiments of the invention. It is to be understood that the drawings are diagrammatic and schematic representations of such exemplary embodiments, and are not limiting of the present invention, nor are they necessarily drawn to scale.

I. Operating Environment

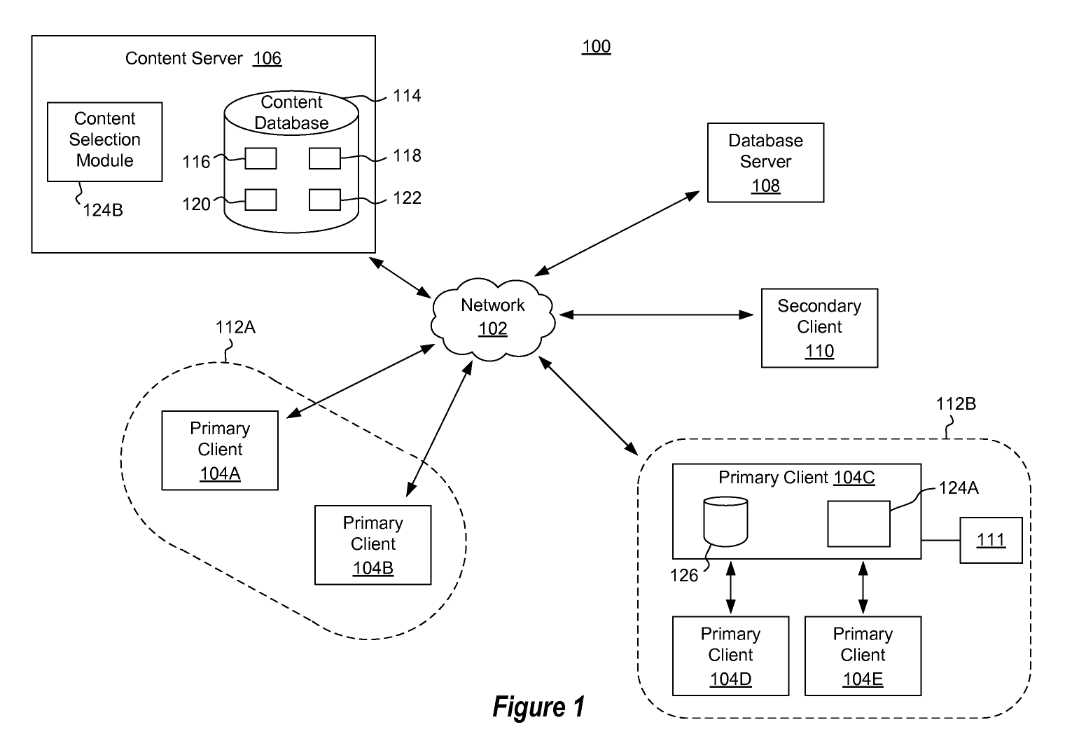

With reference first to FIG. 1, an example operating environment 100 is illustrated in which some embodiments of the invention can be practiced. The example operating environment 100 includes a network 102 used by one or more primary client devices 104, including primary client devices 104A-104E, to communicate with each other, one or more content servers 106 and/or one or more database servers 108. Optionally, the example operating environment 100 additionally includes one or more secondary client devices 110 and/or one or more display devices 111.

The network 102 is illustrated in simplified form and exemplarily includes the Internet, comprising a global internetwork formed by logical, physical and/or wireless connections between multiple wide area networks and/or local area networks. Alternately or additionally, the network 102 includes a satellite network, a cellular RF network and/or one or more wired and/or wireless networks such as, but not limited to, 802.xx networks, Bluetooth access points, wireless access points, IP-based networks, or the like. The network 102 also includes servers that enable one type of network to interface with another type of network.

One aspect of the invention includes that a patient and/or health care provider can interface with a touch unit. A touch unit includes any computing device that has a touch screen that simultaneously serves as a display means as well as a user input means. The touch unit may have any other number of input means such as keyboard, mouse, camera, microphone, and the like. The touch unit can be placed in a waiting room, exam room, or any other location at which a health care provider wishes to interface with patients. One advantage of having a touch unit as opposed to a traditional computer is that a touch screen can present content in an easily navigable fashion that is understood by patients of various educational levels without requiring a patient to have advanced computer skills Similarly, medical professionals will easily be able to train technicians on how to use the patient education touch system without requiring technicians to have advanced computer skills Although some embodiments include having a touch unit at the point of presentment for targeted health care content, the present invention is not limited to a patient and/or health care provider interfacing with a touch unit in all cases. As such, it will be generally understood that a touch unit can be one embodiment for implementing a “primary client device,” “secondary client,” and/or “display.”

As shown in FIG. 1, the primary client devices 104 can be divided into groups according to their association with a particular health care provider, including providers 112A, 112B (collectively “providers 112”). For instance, each of primary client devices 104A, 104B is associated with provider 112A, while each of primary client devices 104C-104E is associated with provider 112B. In some embodiments, the providers 112 comprise health care providers, such as physicians, dentists, chiropractors, nurses, or the like.

The providers 112 are often associated with or work from particular physical facilities that include, e.g., waiting rooms, exam rooms, offices, etc. As such, primary client devices 104 can be located in different rooms of the facilities associated with providers 112. For instance, primary client device 104A can be located in a waiting room of a facility used by provider 112A, while primary client device 104B can be located in an exam room of the same facility. Alternately or additionally, each of primary client devices 104C-104E can be located in different exam rooms of a facility used by provider 112B. As used herein, the terms “provider” and “providers” should be broadly construed to include one or more health care providers, employees of and other staff associated with the health care providers, and/or the physical facilities associated with the health care providers.

Each of the primary client devices 104 and/or secondary client devices 110 comprises a computing device with associated means for receiving input from and/or providing output to (“I/O means”) a user. For instance, each of the primary client devices 104 and/or secondary client devices 110 can comprise a personal computer with one or more of a keyboard, mouse, touch-sensitive screen, camera, or other I/O means, one example of which is marketed by the Hewlett-Packard Company as the HP TouchSmart PC. Alternately or additionally, each of the primary client devices 104 and/or secondary client devices 110 comprises a laptop computer, desktop computer, wireless or mobile telephone, a Personal Digital Assistant (“PDA”), a smartphone, or any other computing device having I/O means and configured to communicate over the network 102.

A content server 106 communicates with one or more of primary client devices 104 via network 102. The content server 106 stores digital content in a remote content database 114. The digital content comprises one or more of text, images, graphics, photographs, video, audio, forms, or other digital content. Further, the digital content generally includes health care content relating to one or more specific health care practice areas, such as family practice, pediatrics, orthopedics, obstetrics and gynecology (“OB/GYN”), dermatology, plastic surgery, to name a few. In the example of FIG. 1, the digital content included in remote content database 114 includes orthopedic content 116, OB/GYN content 118, dermatological content 120, and plastic surgery content 122. More generally, however, the digital content included in remote content database 114 can include health care content relating to one or more of the practice areas identified herein and/or any other different practice area.

As used herein, “health care content” refers to health-related content that generally serves to educate a patient or user with respect to an aspect of health care. For instance, health care content can include, among other things, descriptions/diagrams/3-D models/videos of particular medical procedures, pre/post-operative patient instructions for particular medical procedures, lists of symptoms associated with particular illnesses/medical conditions, frequently asked questions and corresponding answers associated with certain medical procedures/conditions, patient-specific data relating to a medical condition and/or quantifiable health care indicator of a patient, or the like or any combination thereof.

Health care content is generally tagged with one or more keywords tagged such that the content can plug into targeted searching capabilities to target the new content to patients for which it would be most useful. For instance, digital content can be tagged as relating to a particular medical condition, patient interest, or the like. The digital content can be tagged automatically by content selection module 124A on primary client device 104C. For instance, the content selection module 124A can parse the digital content to identify content, metatags, summaries, or other characteristics of the digital content that identify the subject matter of the digital content and tag the digital content accordingly. The tags assigned to the digital content can then be matched up with one or more tags relating to medical conditions or other user data associated with the patients of the service provider. Alternately or additionally, an administrator or other user can manually input particular tags to the digital content. Further, the digital content can be tagged before the content is delivered to the database server 108.

In some embodiments, the digital content stored in remote content database 114 is made available to providers 112 on a subscription or usage basis. For instance, providers 112 can pay a flat-rate subscription fee to access some or all of the digital content in remote content database 114. Alternately or additionally, the cost of a subscription to access all of the content in remote content database 114 can be relatively more expensive than the cost of a subscription to access only one type of content 116, 118, 120, or 122. As such, providers 112 can opt to subscribe for access to only the content 116, 118, 120, and/or 122 that is most closely associated with a particular practice area of the provider 112.

With continuing reference to FIG. 1, the database server 108 stores user data for a plurality of patients in user accounts of the patients. In one example, the database server 108 is part of an electronic records management (“ERM”) or electronic medical records (“EMR”) system that generally allows health care providers to electronically store user data. While database server 108 and content server 106 are shown separately for convenience of describing the invention, in some embodiments, the database server 108 and content server 106 may be the same server such that the primary client devices 104 and secondary client devices 110 interface with the combined content/database server 106/108. Where the database server 108 and content server 106 are separate devices, the primary client devices 104 and secondary client device 110 can access them individually. Alternatively, where the database server 108 and content server 106 are separate devices, the content server 106 additionally provides an interface between the primary client devices 104/secondary client devices 110 and the database server 108. For instance, the content server 106 can receive and process read/write requests from the primary client devices 104 and/or secondary client devices 110 that are directed to the database server 108.

In some embodiments, the group of primary client devices 104 associated with a particular provider 112 includes at least one master client device and one or more slave client devices. For instance, the primary client device 104C is a master client device while the primary client devices 104D, 104E are slave client devices. As such, the master primary client device 104C communicates with the content server 106 and/or database server 108 to send and receive data, including digital content, while the slave primary client devices 104D, 104E send and receive data to/from the content server 106 and/or database server 108 via the master primary client device 104C. In this example, the master primary client device 104C includes a content selection module 124A and a local content database 126.

In other embodiments of the invention, operating environment 100 implements a cloud computing format where every primary client device 104 is its own master. Alternately or additionally, the primary client devices 104 associated with a particular provider 112 do not include a master client device and all of the associated primary client devices 104 are configured to communicate directly with the content server 106 and/or database server 108. For instance, both of primary client devices 104A, 104B communicate directly with the content server 106 and/or database server 108 without communicating via a master client device. In this example, the content server 106 further includes a content selection module 124B.

Accordingly, content selection modules 124A, 124B can be implemented in one or both of a master primary client device 104C or the content server 106. Briefly, the content selection module 124A, 124B identifies targeted health care content to deliver to patients or other users via the primary client devices 104 and/or secondary client devices 110. Targeted health care content refers to health care content that is identified and delivered to a particular patient based on user data associated with a particular patient. This can be done either manually or automatically, as described further below. User data includes the medical history, current medical condition or reason for visit, quantifiable health indicators (e.g., age, weight, height, blood pressure, heart rate, BMI, etc.), and/or other aspects of a patient's past and current health status. Alternately or additionally, user data includes the patient's name and/or other identifying information such as social security number, date of birth, and the like. Alternately or additionally, user data includes preferences of the patient, interests of the patient, and/or a username/pas sword to allow the patient to access a user account associated with the patient.

The content database 106 cooperates with one or more of content selection modules 124A, 124B and one or more primary client devices 104 to form a targeted health care content delivery system.

In some embodiments, the example operating environment 100 generally operates as follows, using the master/slave configuration of provider 112B. Upon initializing the content selection module 124A, the content selection module 124A retrieves digital content from the content server 106 and stores it locally in local content database 126. Thereafter, the content selection module 124A automatically pushes and/or pulls digital content updates to and/or from the content server 106 when content server 106 receives updated content, at predetermined intervals, or upon a manual request. The content selection module 124A may additionally store user data locally in the local content database 126 or in other local storage and can optionally write user data to the database server 108.

Generally, a patient arrives at a provider 112 to receive health care services. In some cases, the patient waits in a waiting room where the patient may be able to view and/or hear content delivered via one or more of the display 111 or primary client devices 104 prior to meeting with the provider 112. Display 111 represents a device that is primarily used for displaying content, while primary clients 104C, 104D, 104E represent devices that are capable of both outputting content as well as receiving input. For instance, the display 111 may comprise a television delivering televised content. In some embodiments, one or more of the primary client devices 124C-124E is communicatively coupled to the display 111 and is configured to replace advertising content, e.g., commercials, with marketing content of the provider 112B. In this manner, the provider 112B can make patients in the waiting room aware of health care services the provider 112B offers. Alternately or additionally, a primary client device 104C, 104D or 104E in the waiting room can be configured to deliver broad health care content and/or non-health care content to patients in the waiting room.

Alternately or additionally, the patient is escorted to an exam room that includes a primary client device 104. A nurse, medical technician, office assistant, and/or other individual associated with the provider 112 requests and/or measures user data from the patient and inputs the user data via the primary client device 104 in the exam room during registration for the visit. Alternately or additionally, a doctor inputs user data associated with the patient via the primary client device 104 in the exam room or at another input device elsewhere in the office, including a diagnosis of a medical condition of the patient, a medical note, or the like. Alternately or additionally, the patient inputs user data via the primary client device 104 in the exam room or at another input device elsewhere in the office, including defining preferences regarding content delivery for the patient and/or identifying interests of the patient (“patient interests”) in particular services provided by the provider 112 and/or in other topics, defining a username and password, etc.

According to some embodiments of the invention, the patient identifies patient interests by selecting one or more patient interests from a list of potential patient interests that are displayed to the patient via primary client device 104 and/or secondary client device 110. In this example, the list of potential patient interests may comprise a list of procedures or other topics relevant to a provider's 112 practice for which the patient may want to receive notifications in the future. In this and other examples, the patient can select a particular patient interest by clicking on or otherwise selecting a corresponding icon or button displayed on the primary client device 104 and/or secondary client device 110.

The list of potential patient interests can be displayed to the patient at any time during the patient's visit. In some examples, the list of potential patient interests is displayed to the patient after completing a medical procedure or other visit and prior to the patient leaving the provider's 112 facilities. For instance, after receiving an eyebrow lift from a provider 112 such as a plastic surgeon, the patient can be shown on one of primary client devices 104 or display 111 a list of other services/procedures offered by the plastic surgeon. The selection by the patient of one or more of the other services/procedures from the list can be locally and/or remotely saved as a patient interest(s) in a user account of the patient. Assuming the patient has provided an email address or other contact information in the patient's user account, the content selection module 124A, 124B can notify the patient in the future any time new digital content relating to any one of the patient's interests is added to the content server 106 and made available to the plastic surgeon. Alternately or additionally, any time the plastic surgeon's pricing changes with respect to patient interests or any other significant changes occur with respect to patient interests, the content selection module 124A, 124B and/or the plastic surgeon can notify the patient of the change, thereby allowing the plastic surgeon to reach out to patients having the relevant patient interests.

In systems that include a master primary client device 104C, user data that is input at the slave primary client devices 104D, 104E is transmitted to the master primary client device 104C and can be locally stored in the local content database 126 and/or in other storage along with user data entered at the master primary client device 104C. Alternately or additionally, the user data transmitted to and/or input at the master primary client device 104C can be written to the database server 108.

Alternately or additionally, in systems that lack master/slave client devices, user data that is input at primary client devices 104A, 104B can be locally stored on primary client devices 104A, 104B and/or written to the database server 108.

In some embodiments, the patient can navigate a user interface of the primary client devices 104 using corresponding I/O means to access particular digital content in the remote content database 114 and/or local content database 126.

Alternately or additionally, a provider 112 or employee of the provider 112 can navigate the user interface of the primary client device 104 to manually select particular digital content for the patient. For instance, if the patient has been diagnosed with a specific medical condition, such as a torn ligament, the provider 112 or employee of the provider 112 can select digital content relating to the specific medical condition that the patient can view/listen to, such as digital content relating to available medical treatments for torn ligaments in the present example.

Alternately or additionally, the content selection module 124A, 124B can automatically select digital content for delivery to the patient via the primary client device 104 or secondary client device 110. In this case, the content selection module 124A, 124B can receive the user data collected during the patient's current visit and/or retrieve additional user data previously stored in the database server 108 and identify specific health care content for the patient based on the user data. For instance, if the user data indicates that the patient is three months pregnant, the content selection module 124A, 124B can identify and deliver digital content to the patient relating to the development of a fetus at three months, common physiological changes experienced during pregnancy and/or during a particular trimester of pregnancy, risks associated with a particular trimester of pregnancy, or the like. Advantageously, this allows specific health care content to be delivered to the patient based on the patient's past/current condition instead of broad content that may not be relevant or interesting to the patient. This also can make the patient visit more productive by presenting instructional information before the patient meets with the provider, which may help the discussion with the provider be more productive.

In some cases, the content selection module 124A, 124B automatically selects digital content for delivery to the patient that the provider desires to block until such time as deemed relevant by the provider. For instance, for a pregnant patient, the content selection module 124A, 124B may automatically select digital content relating to the fifth month onward of pregnancy based on user data indicating that the patient is pregnant. However, if the patient is only in the fourth month of pregnancy, the provider may desire to block the digital content for any one of a numbers of reasons. For example, the provider may prefer to deliver the digital content to the patient at a later time (e.g., during the patient's fifth month of pregnancy) when the digital content is more relevant. Alternately or additionally, the provider may block the digital content to avoid confusion about potential issues that are unlikely to affect the patient until a later time. Accordingly, embodiments of the invention allow the provider to block or otherwise prevent access by the patient to certain digital content identified by the content selection module 124A, 124B. For instance, the provider can block the delivery of certain digital content via a user interface of the primary client devices 104 and/or via other input devices.

Alternately or additionally, when the user data includes one or more quantifiable health indicators, such as age and/or height, the content selection module 124A, 124B can identify and deliver digital content to the patient regarding a norm for a quantifiable health indicator, such as an average weight of individuals of the same age and/or height as the patient. Or, normal growth of a fetus as compared to the measured size of the patient's fetus at that particular stage of development. Alternately or additionally, the content selection module 124A, 124B can generate a chart(s) that graphically compares a particular patient's quantifiable health indicator(s) to the norm and/or that utilizes past and current measurements of the same quantifiable health indicator(s) to visually display the patient's particular quantifiable health indicator(s) as a function of time.

In some embodiments of the invention, the provider 112 desires the patient's signature/authorization for one or more purposes, such as acknowledgment of disclosure, consent to a particular medical procedure, consent for the provider 112 to access the patient's medical records from another provider, consent to share the patient's medical records with another provider, and the like. In this case, the provider 112 or employee of the provider 112 navigates the user interface of the primary client device 104 to retrieve an appropriate form in an electronic format from the remote content database 114 or local content database 126 that can be displayed to the patient via the primary client device 104 in the exam room in which the patient is located. Alternately or additionally, the content selection module 124A, 124B automatically identifies and retrieves an appropriate form based on user data received from one of primary client devices 104. After the patient has reviewed the electronic form, the primary client device 104 can capture authentication data indicative of the patient's authorization. For instance, a touchscreen of the primary client device 104 can electronically capture the patient's signature. A camera can capture an image of the patient at the time the patient is writing his/her signature, providing an added layer of authentication. Alternately or additionally, other layers of authentication can be provided.

Capturing the patient's authorization provides one example of where the primary client devices 104 can be modified as needed depending on patient needs. For example, for an immobile patient or handicapped patient, the primary client device 104 may include a simple touch screen unit that communicates with primary client device 104 at short range via wired or wireless communication. For example, a Bluetooth connection would adequately provide enough range to enable a smaller touch screen unit, such as a tablet PC, tablet PDA or other device which can capture a patient's handwriting to be connected to the primary client device 104.

In the case where the patient authorizes the provider 112 to access the patient's medical records via an electronic form, and assuming that contact information for another provider that has treated the patient is available to the content selection module 124A, 124B, the content selection module 124A, 124B forwards the signed electronic form to the other provider. After receiving the signed electronic form, the other provider can release the patient's medical records to the provider 112. In one embodiment, the other provider is able to send the requested medical records within a short period of time so that the provider 112 can review the requested medical records during or shortly after the visit with the patient. Advantageously, having the requested medical records available at or near the time of the visit with the patient can help alert the medical provider 112 to any additional information that should be considered to adequately care for the patient. In addition, the requested medical records can serve as additional input as user data, thus triggering an update of health care content that can be served to the patient. For example, the combination of requested medical records with the patients other user data may result in a complication that was not considered beforehand, but for which complication the medical provider 112 would now appreciate content to be used to educate the patient. Alternately or additionally, in some embodiments where medical records from the other provider are stored in the database server 108, the content selection module 124A, 124B automatically identifies and retrieves the medical records created by the other provider for the provider 112 after receiving the authorized electronic form from the patient.

According to some examples, one or more of primary client devices 104 includes drawing tools that permit a provider 112 to graphically illustrate concepts to the patient on a display of the primary client device 104. In some embodiments, the drawing tools may permit the provider 112 to draw on an image, series of images, or video of the patient, another individual, or an anatomical model. For instance, a provider 112 such as a plastic surgeon may use a primary client device 104 to obtain an image of the patient's face (or use a pre-existing image of the patient's face stored in database server 108 or other location) and then discuss certain procedures with the patient, such as eyebrow lift, forehead lift, rhinoplasty, or the like, while marking areas of the image that would be affected by the procedures discussed with the patient.

As another example, a provider 112 such as an orthopedic surgeon may use primary client device 104 to retrieve an image, series of images, or video of the interior of a first patient's knee or other joint taken during an endoscopic procedure to explain to a second patient suffering from a similar condition as the first patient how the condition can be corrected through a similar endoscopic procedure. In this example, the provider 112 can show to the second patient an image of the interior of the first patient's joint before the procedure and/or another image of the interior of the first patient's joint after the procedure and use the drawing tools to markup one or both of the images to illustrate and explain to the second patient exactly how the second patient's condition can be corrected through the endoscopic procedure. Note that the specific scenarios involving the drawing tools that have been described herein are provided by way of example only and should not be construed to limit the invention in any way.

In some embodiments, digital content delivered to the patient during the visit to the provider's 112 facilities can be flagged or otherwise identified such that the patient can review the digital content at a later time. Alternately or additionally, any user data obtained by the provider 112 and delivered to the patient during the patient's visit, such as test results, x-rays, ultrasounds, etc., can be flagged for the same purpose. Accordingly, after the patient leaves the provider's 112 facilities, the operating environment 100 allows the patient to access digital content and/or user data via the secondary client device 110, which comprises a home PC, laptop, PDA, mobile phone, or other computing device of the patient, for example. For instance, in some embodiments, the content server 106 hosts a website accessed through a browser or other application executing on the secondary client device 110.

Optionally, the patient logs in to the website using a username and/or password. In some embodiments, after the user logs in to the website, the content selection module 124B automatically populates the user interface with links to flagged digital content/user data. As such, the patient can re-access the digital content/user data from the earlier visit by selecting the appropriate link to review the digital content/user data in more detail, and/or to share the digital content/user data with a spouse, other family member, and/or friends, if desired. Alternately or additionally, an email, IM, text message, MMS, VOIP, or other message may be sent to the patient after the visit to let the patient know where to access the flagged content or deliver messages to the patient relating to the user data.

In some embodiments, after logging in to the website, the website presents a graphical user interface (“GUI”) referred to herein as a patient dashboard to the patient. The patient dashboard generally allows the patient to create, edit, and/or view user data associated with the patient, access some or all of the digital content presented to the patient during a previous visit to the provider 112, access other digital content relating to patient interests, and the like or any combination thereof. Optionally, the patient dashboard implements one or more features enabled by the Windows 7 operating system, such as the ability to grab images and pull into a central area, expand multi-touch, grab edges of images to make the images bigger or smaller, presenting multiple topics in one screen frame, and the like or any combination thereof.

Alternately or additionally, new digital content can be added to the remote content database 114 on an ongoing basis. The new digital content may relate to, for example, new medical developments, new drugs, or the like. In some cases, the new digital content is tagged such that the new digital content can plug into existing targeted searching capabilities to target the new content to patients for which it would be most useful. For instance, new digital content can be tagged as relating to a particular medical condition, patient interest, or the like. In this example, upon identifying new digital content tagged as relating to a particular medical condition or patient interest, the content selection module 124B checks the user accounts in the database server 108 for patient user data that have the particular medical condition or that have identified the patient interest and then delivers the new digital content to the patient(s).

II. Content Selection Module

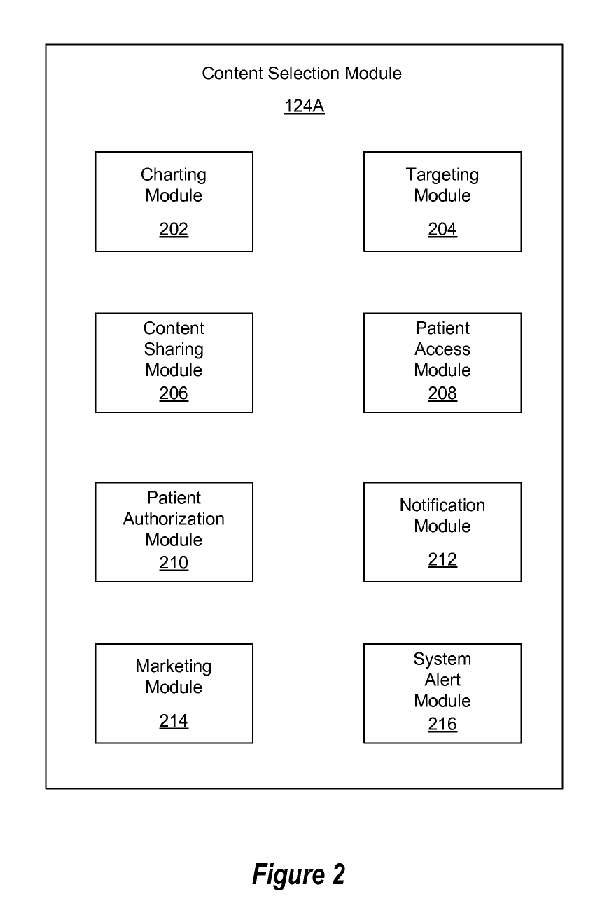

With additional reference to FIG. 2, aspects of the content selection module 124A are described in greater detail. Aspects of the content selection module 124B are similar to aspects of the content selection module 124A and will not be described in significant detail herein. As shown in FIG. 2, the content selection module 124A includes a charting module 202, a targeting module 204, a content sharing module 206, a patient access module 208, a patient authorization module 210, a notification module 212, a marketing module 214, and a system alert module 216. In other embodiments, the content selection module 124A is implemented with more or fewer modules than shown in FIG. 2.

In more detail, the charting module 202 is configured to generate one or more charts that graphically represent one or more of the patient's quantifiable health indicators, a norm, or any combination thereof. As used herein, a norm generally refers to a normal or acceptable range of a given quantifiable health indicator and/or an average or median measurement of the quantifiable health indicator and is usually based on the patient's current age and gender. The charting module 202 can generate such charts using one or more current and/or past measurements of a quantifiable health indicator and/or a norm for the quantifiable health indicator.

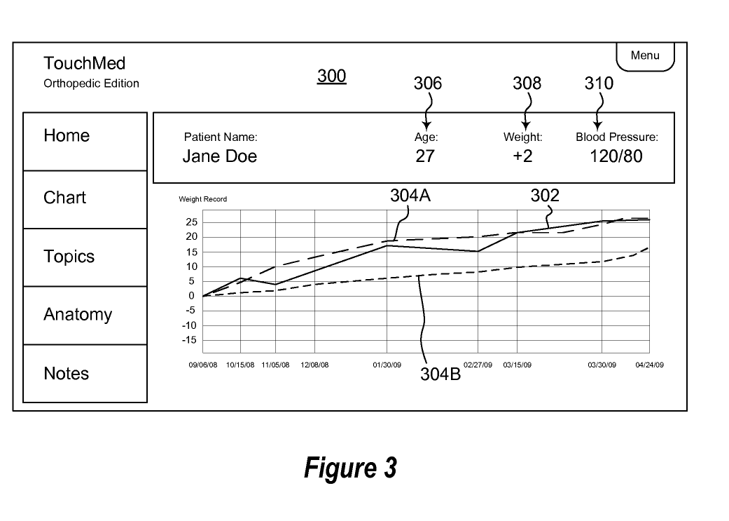

For example, FIG. 3 illustrates one example of a chart 300 generated by the charting module 202 according to some embodiments of the invention. The chart 300 graphically represents the weight gain of a patient “Jane Doe” as a function of time. The x-axis represents time, and includes the dates of specific visits of the patient to the provider. The y-axis represents weight gain or loss, starting from a base of 0 at the patient's first visit on Sep. 6, 2008. At the patient's first visit and each subsequent visit, the patient's weight (or weight gain/loss) was recorded by the provider and stored in the user account of the patient at the database server 108. As such, at a visit on Apr. 24, 2009, the charting module 202 collects all of the patient's prior weight (or weight gain/loss) measurements and generates the curve 302 representing the patient's weight gain as a function of time. It is appreciated that the chart 300 only illustrates one manner in which a quantifiable health indicator of a patient can be graphically represented and that other manners can alternately or additionally be employed.

Although not required, in the example of FIG. 3, the chart 300 further includes a norm 304, including curves 304A and 304B, for the quantifiable health indicator, e.g., weight gain, that is graphically represented in the chart 300. More particularly, the patient Jane Doe in the present example is pregnant and the curve 302 represents the patient's weight gain during about the first 33 weeks of her pregnancy. The upper curve 304A and the lower curve 304B of the norm 304 define a normal range therebetween corresponding to normal weight gain during pregnancy. Accordingly, the charting module 202 in the present example generates the chart 300 by further retrieving digital content for the norm 304 based on user data including the patient's medical condition (e.g., pregnant) and/or other quantifiable health indicators, such as the patient's age and/or height. Thus, the norm 304 and/or other norms charted for a patient can be tailored specifically to the patient based on the patient's personal user data. The digital content for the norm 304 is one example of targeted health care content that can be delivered to a patient by content selection module 124A.

Alternately or additionally, the chart 300 includes one or more other quantifiable health indicators, such as the patient's age 306, weight gain 308 from a previous visit, blood pressure 310, or the like or any combination thereof. After generating the chart 300, assuming the patient is in an exam room with a primary client device 104, the charting module 202 delivers the chart 300 to the patient via the primary client device 104. Alternately or additionally, the charting module 202 delivers the chart 300 to the patient via secondary client device 110.

The generation of charts, such as the chart 300, by the charting module 202 to graphically represent patient conditions, including quantifiable health indicators, can be valuable to providers and patients. For instance, many providers choose not to chart patient conditions due to the time and effort involved in charting the patient's condition and/or in obtaining a norm based on the patient's personal user data. However, the charting module 202 allows providers to easily chart patient conditions by automatically generating charts with user data that has been input through primary client devices 104. Alternately or additionally, charts allow patients to easily visualize the patient's condition and/or whether the patient falls within the norm. Charts further allow providers to emphasize to the patient the severity of a particular condition as being outside the norm. The chart also allows providers or content selection module 124A to evaluate quantifiable health indicators against particular events. For example, also charted could be one or more points in time when a patient took a particular medication, which can help explain fluctuations in quantifiable health indicators. By displaying this to a patient, a provider can help confirm with the patient that a particular treatment is working as planned, or that changes may need to be made.

Returning to FIG. 2, the targeting module 204 is configured to identify targeted health care content for delivery to a patient based on user data. For instance, when a patient is first escorted to an exam room with a primary client device 104, the patient may have to wait for a time before a doctor can see the patient. While the patient waits, a nurse or other individual can input certain user data in the primary client device 104 which is communicated to the content selection module 124A and/or targeting module 204. The user data can include, for instance, the patient's name, the patient's current medical condition or reason for visit, and so on. The targeting module 204 analyzes the user data, and optionally other user data for the patient already stored in the database server 108, to identify and deliver targeted health care content to the patient.

For example, if the user data includes past medical history indicating that the patient is suffering from a particular medical condition, such as a torn ligament, the targeting module 204 can retrieve digital content relating to treatment options for the medical condition. Alternately or additionally, if the user data indicates that the reason for the patient's visit is to discuss a particular type of plastic surgery with the provider, the targeting module 204 can retrieve digital content relating to the particular type of plastic surgery and/or plastic surgery in general. These are only a few examples of user data and corresponding targeted health care content that may be identified and delivered by the targeting module 204 based on the user data. In other examples, the targeting module 204 can identify and deliver the same or other targeted health care content based on the same or other user data.

Once targeted health care content has been retrieved by the targeting module 204, the targeted health care content is delivered to the patient. The targeted health care content can be delivered to the user in one or more of a variety of ways. In some embodiments, the targeting module 204 communicates with the primary client device 104 while one or more of the patient or the nurse or other individual that input the user data is still in the exam room. The primary client device 104 then communicates to the patient, nurse or other individual via a user interface of the primary client device 104 that targeted health care content is available, whereupon the patient, nurse or other individual interacts with the user interface to view and/or listen to the targeted health care content.

Alternately or additionally, after the targeting module 204 communicates to the primary client device 104 that targeted health care content is available, the primary client device 104 automatically begins displaying/rendering the targeted health care content to the patient without first requiring the nurse, other individual or patient to first interact with the user interface of the primary client device 104.

Alternately or additionally, the targeting module 204 can deliver targeted health care content to the patient via secondary client device 110. For instance, in some embodiments the targeting module 204 sends an electronic message containing the targeted health care content, a link to the targeted health care content, or a link to a website that can be accessed to retrieve the targeted health care content, to the patient. The patient uses the secondary client device 110 to access the electronic message and/or the targeted health care content. In one embodiment, the directed health care content is password protected so that confidential information about the patient's condition remains secure.

Alternately or additionally, in some examples the targeting module 204 flags the targeted health care content such that it can be easily identified for the patient when the patient accesses a website hosted by the content selection module 124A. This method of delivery of targeted health care content can optionally be combined with the delivery of an electronic message containing a link to the targeted health care content or a link to a website that can be accessed to retrieve the targeted health care content.

Accordingly, embodiments of the targeting module 204 provide the patient with targeted health care content based on user data associated with the patient. In some cases, the patient accesses the targeted health care content while the patient is waiting for a doctor or other provider in an exam room or other location. As a result, the patient may be more likely to feel that wait time has been well-spent and less likely to feel frustrated about having to wait to see the doctor or other provider. Alternately or additionally, when the patient meets the doctor or other provider, the patient may be more informed about the patient's medical condition and/or reason for visit and may be more aware of what questions to ask regarding the patient's medical condition and/or reason for visit.

In other embodiments, the patient accesses the targeted health care content after the visit to the provider and using a secondary client device 110 associated with the patient. Consequently, the patient can access targeted health care content after the visit and at the patient's convenience to review information that the patient may have forgotten since leaving the provider and/or to share targeted health care content related to a medical condition of the patient, etc., with the patient's family and/or friends.

With continuing reference to FIG. 2, the content sharing module 206 is configured to facilitate the sharing between different providers of medical records and other user data collected by the providers. For instance, under the Health Insurance Portability and Accountability Act (“HIPAA”), a first provider typically cannot share medical records of a patient with a second provider without the patient's consent.

Generally, when a first provider desires to obtain the patient's authorization to access the patient's medical records and other user data collected by one or more second providers, the first provider provides the patient with a form for the patient's signature. The form can be in hardcopy or electronic form and can optionally be obtained using the patient authorization module 210 as will be explained in greater detail below. If the patient agrees to allow the first provider to access the patient's medical records and other user data collected by the second provider, the patient signs the form.

In some embodiments, the content sharing module 206 accesses one or more provider directories stored locally in local content database 126 or other local storage and/or stored remotely in remote content database 114 to retrieve and display contact information for the second provider to the first provider. Alternately or additionally, the content sharing module 206 automatically communicates the patient's signed form to the second provider and requests that the second provider forward copies of the patient's medical records to the first provider in some embodiments where the signed form is in an electronic format and/or where the content sharing module 206 retrieves an electronic contact address for the second provider from the provider directory. Alternately or additionally, after receiving a signed form in electronic format, the content sharing module 206 automatically sends a read request to the database server 108 to retrieve medical records collected by the second provider in some embodiments where the second provider stores medical records for the patient on the database server 108.

The patient access module 208 is configured to allow the patient to remotely access targeted health care content and/or the patient's personal user data via a secondary client device 110. In particular, the patient access module 208 presents a patient dashboard to the patient through which the patient can access targeted health care content and/or user data stored in the local content database 126, the remote content database 114, and/or the database server 108. For instance, in some embodiments, the patient access module 208 hosts a website to which the patient logs in (e.g., inputs username and password) to access the targeted health care content and/or user data.

In some embodiments, targeted health care content and/or user data is flagged and associated with a particular patient and/or with a particular username or password. The flagging of targeted health care content and/or user data can be performed by one or more of the modules 202-214 or by a separate flagging module (not shown) as the targeted health care content and/or user data is identified and/or communicated to the patient, for instance. When the patient logs in to the website hosted by the patient access module 208 or otherwise accesses the patient access module 208, the patient access module 208 automatically populates the patient dashboard with links to the flagged targeted health care content and/or user data. When the user selects a particular link, the patient access module 208 retrieves the targeted health care content or user data from its location in the local content database 126, remote content database 114, or database server 108 and presents it to the user via the patient dashboard.

Embodiments of the patient access module 208 allow patients to remotely access targeted health care content and/or user data after leaving a provider's facilities. In some embodiments, the ability of the patient to access targeted health care content and/or user data remotely eliminates the need to send hardcopies of targeted health care content and/or user data home with the patient while maintaining the ability of the patient to review the information at the patient's convenience, if desired. As a result, the patient may carry away a perception that the provider has a genuine interest in providing the patient with meaningful information even after the visit to the provider.

Alternately or additionally, the ability of the patient to access targeted health care content and/or user data after the visit allows the patient to share certain information with third parties, including family and friends. As one example, a patient that is pregnant may desire to share an ultrasound and/or targeted health care content relating to a particular stage or stages of fetus growth with a spouse or other individuals. Embodiments of the patient access module 208 enable the patient to access and share such user data and targeted health care content as desired.

Alternately or additionally, embodiments of the patient access module 208 allow the patient to define preferences and/or to identify patient interests that the content selection module 124A may use in identifying and delivering targeted health care content to the patient. The patient interests can include specific health-related topics identified by the patient that the patient is interested in learning more about, without regard to a connection, or lack thereof, of the specific health-related topics to a current or past medical condition of the patient. The defined preferences can identify whether the patient desires to receive targeted health care content or notifications regarding the targeted health care content and an email address, cell phone number, IM address, VOIP address, or other address to which the patient desires the targeted health care content or notifications to be sent.

In the embodiments described herein, the patient access module 208 has been described as part of the content selection module 124A on master primary client device 104C. In other embodiments, however, the patient access module 208 is implemented on the content server 106 as a server-side component of the content selection module 124A, even where one or more of the remaining components 202-206 and 210-214 are implemented on the master primary client device 104C.

Returning to FIG. 2, the patient authorization module 210 is configured to generate electronically signed forms. There are various circumstances that require a signature of the patient indicating acknowledgment or consent. For instance, to perform certain medical procedures, a doctor is required to have the patient sign a form acknowledging that the doctor has explained the risks associated with the medical procedure and/or consenting to the medical procedure. As another example, for a first provider to obtain medical records collected by a second medical provider, the provider is required to have the patient sign a form consenting to the first provider's access to the medical records.

In this and other embodiments, electronic versions of a plurality of such forms are stored in the remote content database 114 and/or the local content database 126. In some examples, the provider navigates a user interface of the primary client device 104 to locate and display to the patient a particular electronic form that is appropriate under the circumstances. For instance, if the provider desires to have access to the patient's medical records collected by another provider, the provider can locate and display a HIPAA authorization form.

In other examples, the patient authorization module 210 is configured to automatically locate and deliver to the patient via primary client device 104 an appropriate electronic form based on user data associated with a patient. For instance, if the provider inputs user data indicating that the patient has been diagnosed with a particular medical condition typically treated with a particular medical procedure requiring patient consent, the patient authorization module 210 automatically locates the electronic form corresponding to the particular medical procedure and delivers the electronic form to the patient via the primary client device 104. Delivering the electronic form to the patient via the primary client device 104 can include communicating, via the primary client device 104, that the electronic form is available, and in response to receiving user input at the primary client device 104, displaying the electronic form to the doctor and/or patient. Alternately or additionally, delivering the electronic form to the patient can include sending a print request to an attached printer to generate a hardcopy of the form.

To aid the patient authorization module 210 in generating electronically signed forms, the primary client device 104 includes one or more input means configured to capture authentication data indicative of the patient's authorization. For instance, the primary client device 104 can include input means configured to electronically capture an image of the patient's signature. Alternately or additionally, the primary client device 104 can include input means configured to electronically capture and timestamp a digital photograph of the patient. Additional layers of authentication can optionally be provided, such as allowing for one or more witnesses to also digitally sign and be captured with a digital photograph.

The patient authorization module 210 cooperates with the primary client device 104 to capture the authentication data. The patient authorization module 210 then appends the captured authentication data to the electronic form to generate the electronically signed form and sends the electronically signed form to the database server 108 for storage. Alternately or additionally, the patient authorization module 210 forwards the electronically signed form, or communicates the availability of the electronically signed form, to the content sharing module 206 to permit the content sharing module 206 to request/retrieve medical records of the patient from a different provider.

With continuing reference to FIG. 2, the notification module 212 is configured to deliver, to patients, new digital content that has been added to the remote content database 114 and/or local content database 126. Delivering the new digital content to the patients includes notifying the patients regarding the availability of the new digital content and/or transmitting the new digital content directly to the patient or to a secondary client device 110 associated with the patient.

When new digital content is added to the remote content database 114 and/or local content database 126, the new digital content can be tagged automatically by the notification module 212 and/or by some other module in the content selection module 124A. For instance, the notification module 212 or other module can parse the new digital content to identify content, metatags, summaries, or other characteristics of the digital content that identify the subject matter of the new digital content and tag the new digital content accordingly. The tags assigned to the new digital content can then be matched up with one or more tags relating to medical conditions, patient interests or other user data associated with the patients of the service provider. Alternately or additionally, an administrator or other user can manually input particular tags to be appended to the new digital content.

In some embodiments, the notification module 212 delivers the new digital content to all patients. In other embodiments, the notification module 212 delivers the new digital content to particular patients in a targeted manner. New digital content delivered to particular patients in a targeted manner is another example of targeted health care content. The new digital content can be targeted to particular patients based on the tags of the new digital content and on user data associated with the patients.

As one example, the notification module 212 can do a keyword search or other type of search of the user accounts stored in database server 108 using the tags of the new digital content. Thus, if new digital content has been tagged as relating to a particular medical condition, a keyword search of the user accounts using the particular medical condition as the keyword may return patients having the particular medical condition. Alternately or additionally, such a keyword search returns patients that have an identified patient interest in the medical condition.

After identifying one or more particular patients as candidates for receiving targeted health care content comprising the new digital content, the notification module 212 delivers the targeted health care content to the particular patients. Alternately or additionally, prior to delivering the targeted health care content to the particular patients, the notification module 212 checks the preferences of the patients to determine if the patients have defined any preferences regarding whether they desire to receive targeted health care content, and only delivers the targeted health care content to those patients that desire to receive targeted health care content.

With continuing reference to FIG. 2, the marketing module 214 is configured to deliver marketing content to patients or other users via the primary client devices 104 and/or the display 111. Marketing content generally includes advertisements and other content that markets products or services to patients or other users. The marketing content may relate to products or services of the provider and/or to products or services of one or more third parties.

For example, in the illustrated embodiment of FIG. 1, the facilities associated with provider 112B include a waiting room in which the display 111 is disposed. One or more of primary client devices 104C-104E is communicatively coupled to the display 111. As already mentioned, in some embodiments, the display 111 comprises a television delivering televised content to patients and other users in the waiting room. In some examples, the televised content is received at the television display 111 as a primary feed and an advertising feed. Further, the primary and/or advertising feeds can be received directly by the television display 111 and/or via one of primary client devices 104C-104E. When the primary feed ends and the advertising feed begins, the marketing module 214 replaces the advertising feed with marketing content from the remote content database 114 or local content database 126.

Alternately or additionally, the marketing module 214 identifies and delivers both broad digital content and marketing content to one or more patients in the waiting room via the display 111 and/or one or more of primary client devices 104C-104E. As used herein, broad digital content refers to digital content that is not targeted to a particular patient or user as described above by referring to user data associated with the particular patient or user. For instance, during cold/flu season, it may be valuable for the provider 112B to deliver broad digital content relating to prevention, symptoms, and treatment of cold/flu to the waiting room. Of course, broad digital content can alternately or additionally qualify as targeted health care content when it is identified and delivered to a particular patient based on user data associated with the patient.

Some embodiments of the marketing module 214 and the marketing content identified and delivered thereby allow providers to make patients aware of new services and/or other services offered by the provider that may not be generally known by patients so as to generate interest in the services. As such, embodiments of the marketing module 214 can serve to educate patients as well as generate additional revenue for the provider 112.

The system alert module 216 is configured to alert the provider 112, the provider's 112 staff and/or the patient regarding procedures and/or dates related to the patient's condition. For instance, if the user data indicates that the patient is pregnant, the system alert module 216 is configured to create alerts related to the condition of being pregnant. Specifically in the present example, the system alert module 128A may create an alert at any time during a patient's visit, such as during checkout (or checkin), that the patient should undergo an ultrasound procedure at the next visit (or the current visit) or at another predetermined point during the patient's pregnancy.

Embodiments of the modules 202-216 can be implemented in one or both of a client-side content selection module 124A or a server-side content selection module 124B. Alternately or additionally, some of modules 202-216 can be implemented on one or more of primary client devices 104 while the remaining modules 202-216 are implemented on the content server 106 and/or the database server 108. Alternately or additionally, embodiments of the content selection modules 124A, 124B do not require all of modules 202-216. Indeed, embodiments of the content selection modules 124A, 124B can include as few as one or more of modules 202-216.

III. Application Map and User Interface

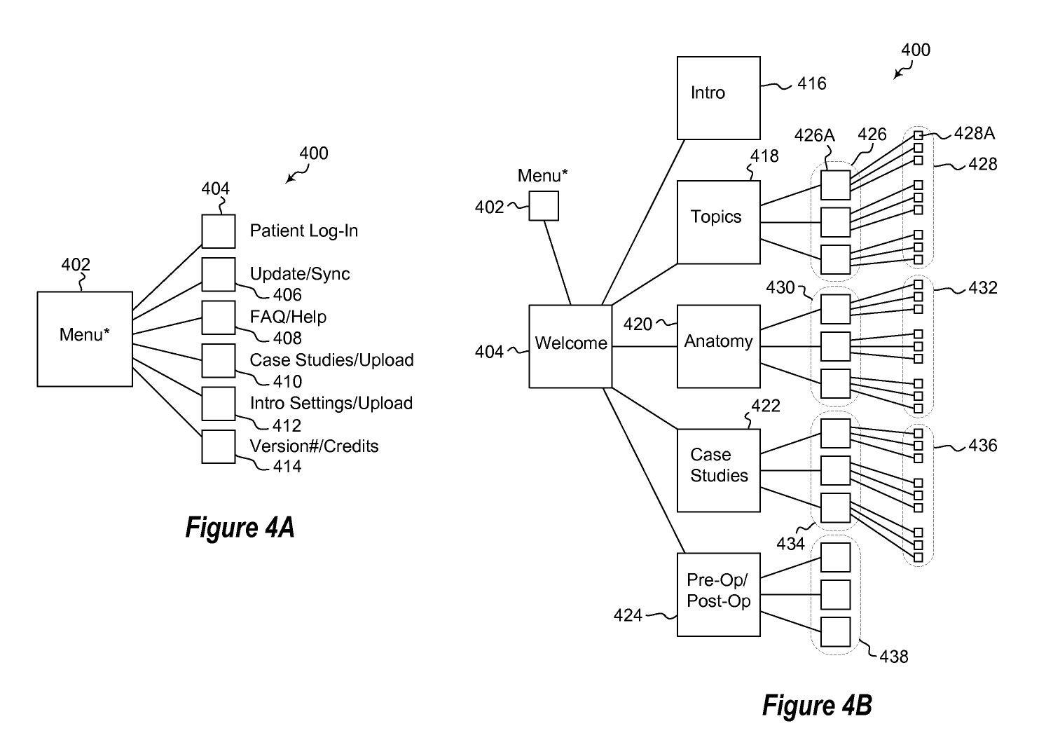

With additional reference now to FIGS. 4A and 4B, one embodiment of an application map 400 that can be employed according to embodiments of the invention is disclosed. The application map 400 generally comprises an access architecture for accessing digital content via the primary client devices 104 of FIG. 1. It should be appreciated that the application map 400 is only one example implementation that can be employed according to embodiments of the invention and that other implementations can alternately or additionally be employed.

As shown in FIG. 4A, the application map 400 includes a root menu 402 presenting a plurality of options 404, 406, 408, 410, 412, 414. With the exception of Patient Log-In option 404, the options 406-414 of root menu 402 are generally used by the provider to perform various functions which are not directly tied to accessing digital content stored in the remote content database 114 and/or local content database 126 of FIG. 1. Aspects of Patient Log-In option 404 are described in greater detail below with respect to FIG. 4B.

The Update/Sync option 406 allows the provider to schedule automatic periodic updates/syncs between the local content database 126 and the remote content database 114. Alternately or additionally, the provider or employee of the provider selects the update/sync option 406 to manually initiate an update/sync between the local content database 126 and the remote content database 114. The update/sync option may also be used to sync the remote content database 114 with other sources of content, such as new digital content that may have become available since the last sync, as described above.

The FAQ/Help option 408 provides the provider with Frequently Asked Questions and corresponding answers and/or other help data relating to the operation of the targeted health care content delivery system of FIG. 1.

The Case Studies/Upload option 410 allows the provider to review and/or upload case studies to the local content database 126 and/or the remote content database 114.

The Intro Settings/Upload option 412 provides the provider with an interface for configuring and uploading digital content for presentation to a patient as an introduction to the targeted health care content delivery system of FIG. 1 and/or the features/functionality of the targeted health care content delivery system.

The Version #/Credits option 414 displays the version number of certain software/hardware included in the targeted health care content delivery system and/or credits associated with the software/hardware.

With additional reference to FIG. 4B, aspects of the Patient Log-In option 404 are disclosed in greater detail. Upon selecting the Patient Log-In option 404 from the root menu 402, the provider or other user is directed to the Welcome option 404 of FIG. 4B. Accordingly, the Patient-Log-In option 404 of FIG. 4A is synonymous with the Welcome option 404 of FIG. 4B. In some embodiments, the option 404 of FIGS. 4A and 4B requires input of a username or password or other identifying information associated with a patient. By requiring identifying information, the targeted health care content delivery system can identify and deliver targeted health care content to the patient based on user data associated with the patient.

In other embodiments of the invention, the option 404 of FIGS. 4A and 4B does not require, or permits, but does not require, the input of identifying information associated with a patient. Whether input of identifying information associated with a patient is required or not, the option 404 provides a patient or other user with access to a plurality of sub-options and/or directories. For instance, the patient can access, via option 404, an Intro sub-option 416, a Topics directory 418, an Anatomy directory 420, a Case Studies directory 422 and/or a Pre-op/Post-op directory 424.

In the example of FIG. 4B, the Intro sub-option 416 provides a patient or other user with general information regarding operation of the targeted health care content delivery system and/or the features/functionality of the targeted health care content delivery system.

The Topics directory 418 generally provides access to health care content relating to specific topics. In some embodiments, the health care content accessed via the Topics directory 418 comprises video content, although this is not required in all embodiments. The Topics directory 418 can include one or more menus 426, including menu 426A, through which health care content is accessed. Alternately or additionally, some or all of menus of 426 can include one or more sub-menus 428, including sub-menu 428A.

The menus 426 and/or sub-menus 428 are typically related to a practice area of the provider. In some examples, for instance, the menus 426 accessed via a Topics directory 418 for a plastic surgeon comprise a body contouring menu, a breast procedures menu, a facial surgery menu, a botox menu, a collagen menu, or the like or any combination thereof. Alternately or additionally, the sub-menus 428 accessed via, e.g., a body contouring menu 426 can comprise a liposuction sub-menu, a tummy tuck sub-menu, a body lift sub-menu, an after major weight loss sub-menu, or the like or any combination thereof. The menus and sub-menus can point to additional sub-menus and/or to health care content.

The Anatomy directory 420 generally provides access to health care content relating to human anatomy. In some embodiments, the health care content accessed via the Anatomy directory 420 comprises image content, although this is not required in all embodiments. Similar to the Topics directory 418, the Anatomy directory 420 can include one or more menus 430 and/or sub-menus 432.

The Case Studies directory 422 generally provides access to health care content relating to particular case studies. In some embodiments, the health care content accessed via the Case Studies directory comprises photographic content of patients or human tissue included in the case studies, although this is not required in all embodiments. The Case Studies directory 422 can include one or more menus 434 and/or sub-menus 436.

The Pre-op/Post-op directory 424 generally provides access to health care content relating to pre-operative and post-operative information and/or forms required for particular medical procedures. In some embodiments, the health care content accessed via the Pre-op/Post-op directory 424 comprises text content, although this is not required in all embodiments. The Pre-op/Post-op directory 242 can include one or more menus 438 and/or sub-menus (not shown).

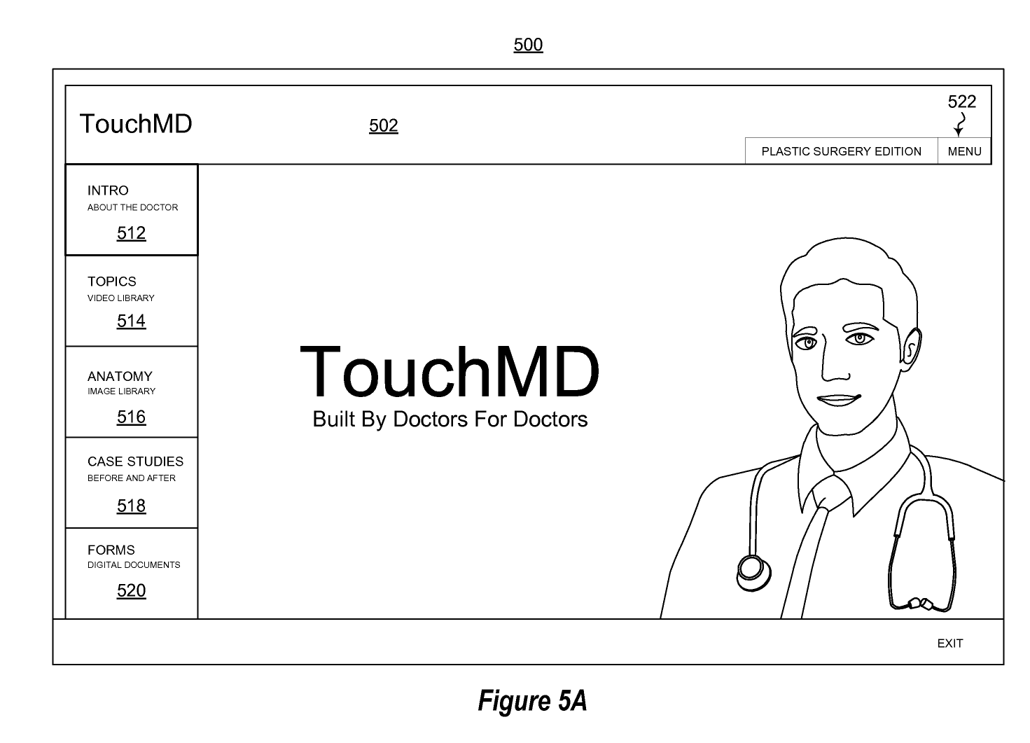

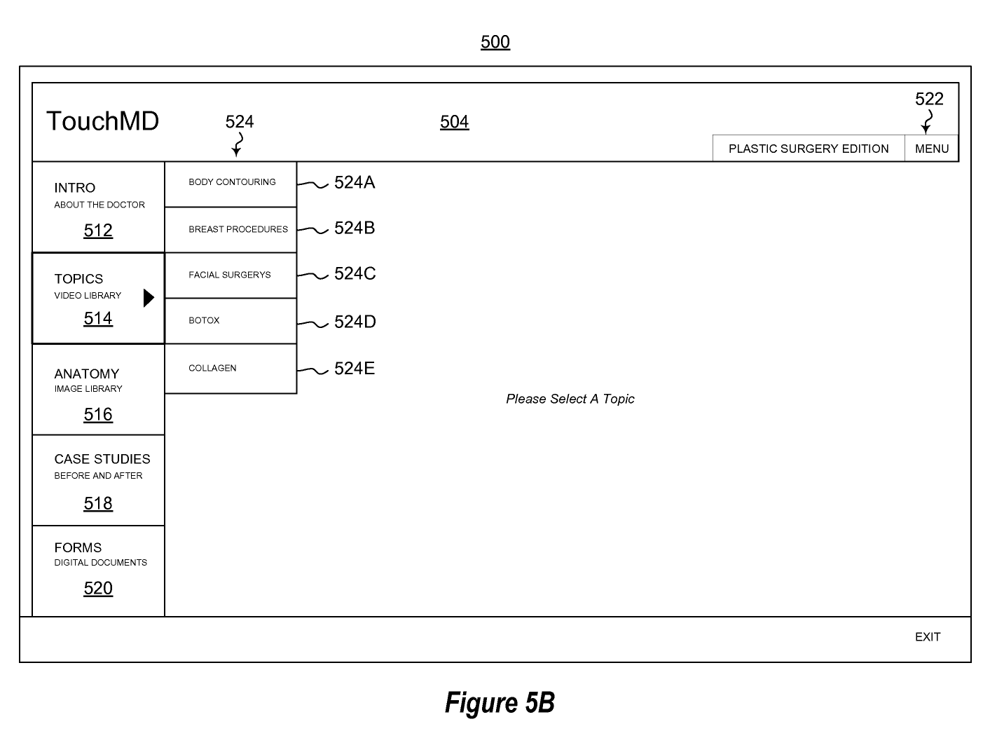

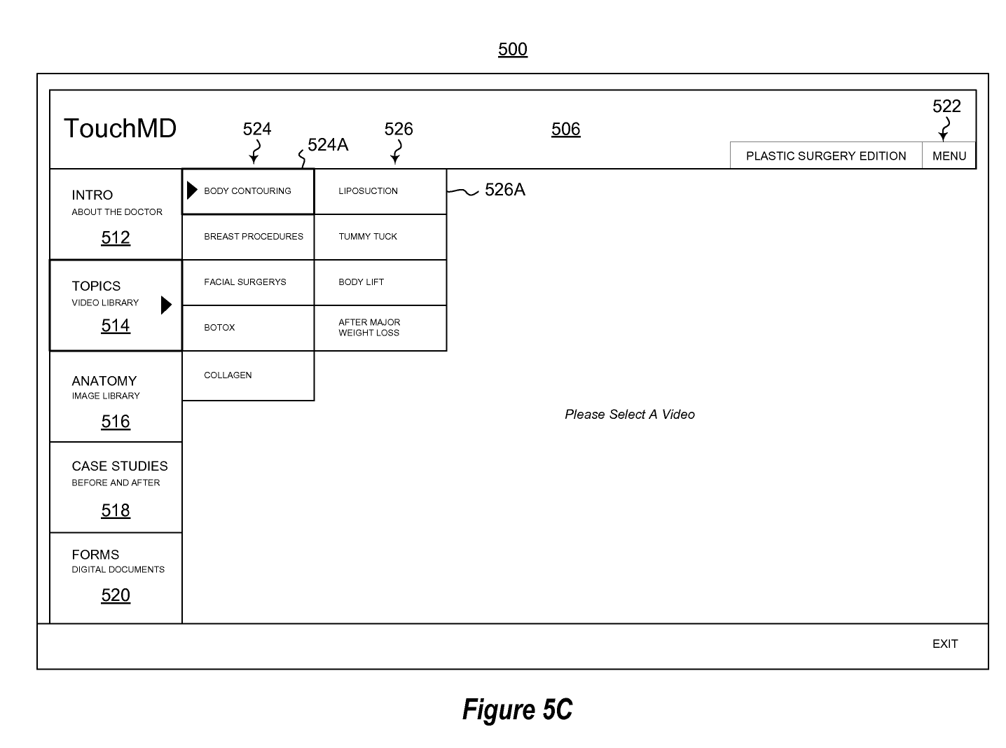

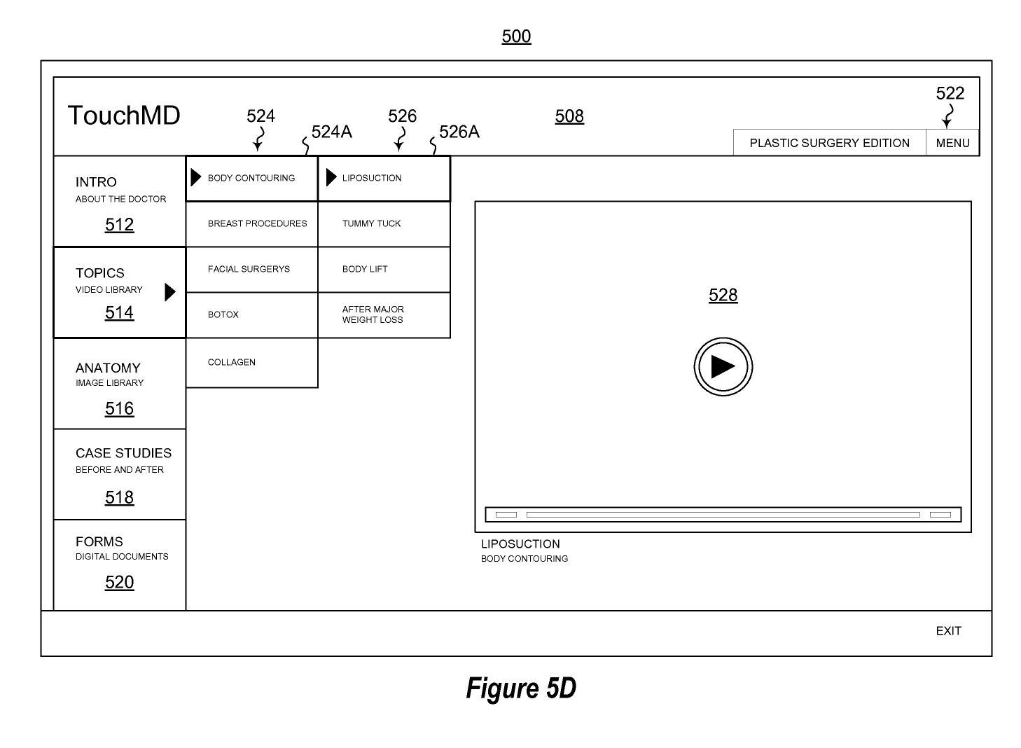

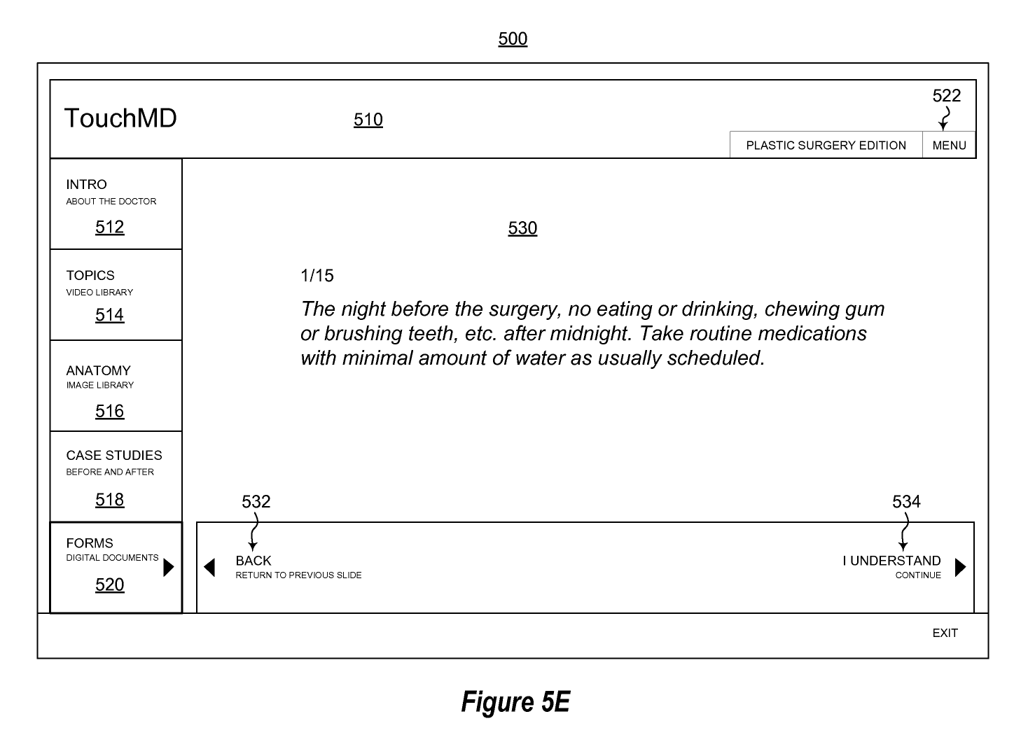

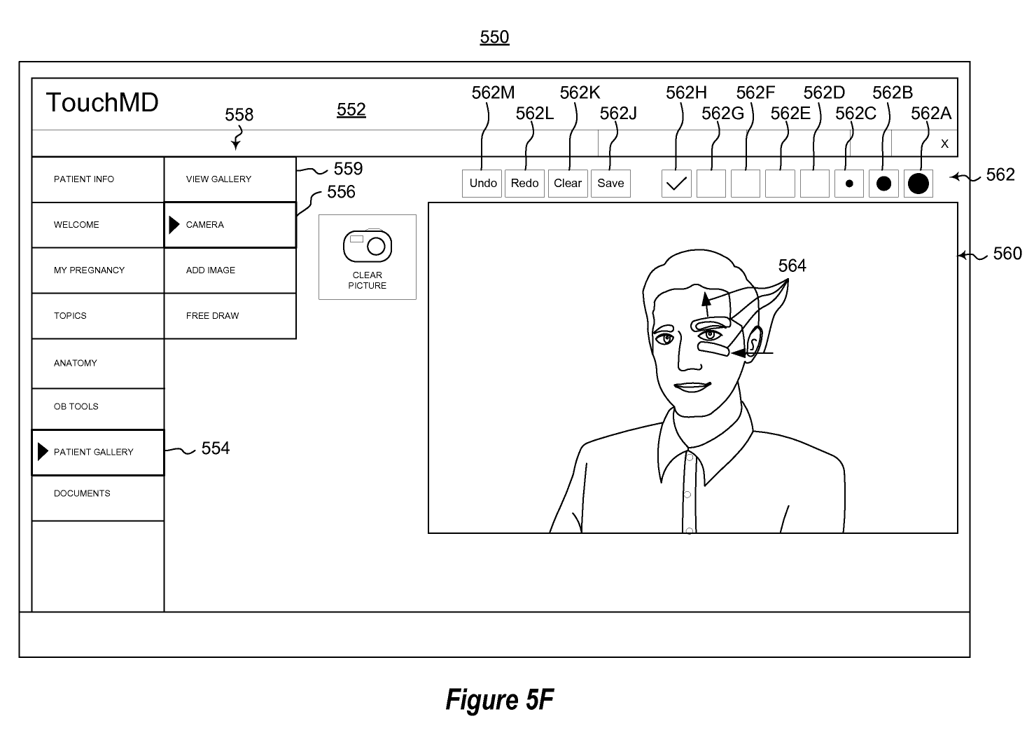

Turning next to FIGS. 5A-5E, one example of a graphical user interface “GUI” 500 is disclosed that can be employed in conjunction with the application map 400 of FIGS. 4A and 4B and displayed to a patient or other user via primary client devices 104. More particularly, FIGS. 5A-5E disclose various screen shots 502, 504, 506, 508 and 510 of portions of the GUI 500 that are displayed in response to the selection of buttons corresponding to certain options, directories, menus, and/or sub-menus of the application map 400. For instance, in FIG. 5A, the portion of the GUI 500 represented by screen shot 502 can be displayed in response to selection of an Intro button 512 corresponding to the Intro option 416 of FIG. 4B.

Screen shot 502 additionally includes buttons 514, 516, 518, 520 corresponding to, respectively, directories 418, 420, 422, 424 of FIG. 4B, as well as a menu button 522 corresponding to the root menu 402 of FIGS. 4A and 4B. Generally speaking, selection of any one of the buttons 512-522 presents the patient or other user with access to one or more additional buttons corresponding to other options, directories, menus, and/or sub-menus of the application map 400 of FIGS. 4A and 4B.

For example, as shown in FIG. 5B, selection of the Topics button 514 provides access to a plurality of menu buttons 524, including menu buttons 524A-524E, corresponding to the menus 426 of FIG. 4B. Similarly, selection of any of the menu buttons 524 provides access to a plurality of sub-menu buttons corresponding to a portion of the sub-menus 428. For instance, as shown in FIG. 5C, selection of menu button 524A provides access to sub-menu buttons 526, including sub-menu button 526A. Further, as shown in FIG. 5D, selection of the sub-menu button 526A results in the display of health care content 528 comprising a video. More generally, however, selection of a menu button or sub-menu button that does not provide access to any other sub-menu buttons results in the display of health care content. Although not shown, the health care content 528 displayed can include an audio component provided via appropriate output means, such as a speaker.

Accordingly, with combined reference to FIGS. 4B and 5D, the menu button 524A corresponds to the menu 426A, and the sub-menu button 526A corresponds to the sub-menu 428A.

As shown in FIG. 5E, selection of the Forms button 520, corresponding to the Pre-op/Post-op directory 424 of FIG. 4B, results in the display of health care content 530 comprising a slide presentation. In the example of FIG. 5E, the GUI 500 can include one or more buttons 532, 534 allowing the patient or other user to navigate through the slide presentation of the health care content 530. More particularly, the button 532 allows the user to return to a previous slide of the health care content 530, and the button 534 allows the user to advance to a subsequent slide of the health care content 530.

FIG. 5F discloses another example of a GUI 550 that can be employed according to some embodiments. The GUI 550 may be employed in conjunction with an application map that is the same or different than the application map 400 of FIGS. 4A and 4B. More particularly, FIG. 5F discloses a screen shot 552 of a portion of the GUI 550 displayed by selecting a “Patient Gallery” button 554 followed by selecting a “Camera” button 556 accessible within a menu 558 accessed through the “Patient Gallery” button 554. Accordingly, the present embodiment permits an image 560 of a patient or other individual or object to be obtained. Alternately, the embodiment of FIG. 5F can be implemented by selecting “View Gallery” button 559 to select one or more pre-existing images or videos of a patient or other individual or object.

The GUI 550 further includes a line drawing tool operated at least in part through buttons 562. In the present embodiment, the line drawing tool permits markings, such as lines 564, to be drawn on the image 560. The buttons 562 of GUI 550 include weight-selection buttons 562A, 562B, 562C that permit a line weight to be selected for the lines 564 that are drawn on the image 560. Color-selection buttons 562D-562G permit a corresponding color to be selected for the lines 564 that are drawn on the image 560. In an actual embodiment, each of color-selection buttons 562D-562G may display as a particular color, which colors are not shown in the black and white line drawing of FIG. 5F.

Button 562H turns the drawing tool on or off. In some embodiments, after the drawing tool is turned on using button 562H or other means, lines 564 are drawn on the image 560 using a mouse (e.g., by holding down the right and/or left button of a mouse and dragging the mouse pointer across the image 560 as desired to create lines 564) and/or using a touch-sensitive screen (e.g., by dragging a finger or stylus across a touch-sensitive screen on which the image 560 is displayed as desired to create lines 564).

Button 562IJ saves the image 560, where the image 560 is linked to a corresponding user account. For instance, if the image 560 is of a patient, the image 560 may be stored in the local content database 126, database server 108, or other storage location, and linked to a user account of the patient such that the patient can access the image 560 at a later time. When lines 564 and/or other markings have been drawn on the image 560, the lines 564 and/or other markings are saved with the image 560 such that the patient can view the lines 564 and/or other markings along with the image 560.

Buttons 562K, 562L and 562M are used to edit the image 560 and lines 564 or other markings. Specifically, selection of button 562K clears all lines 564 or other markings from the image 560. Button 562M is an undo button that erases the last change done to the image 560. Button 562L is a redo button that reverses an undo operation.

The GUI 550 of FIG. 5F discloses aspects of one example of a drawing tool that can be implemented according to some embodiments. In other embodiments, the GUI 550 may include similar and/or different drawing tools that permit lines, comments, shapes, and/or other markings to be made on and/or saved with images 560.

IV. Example Methods of Operating the Targeted Health Care Content Delivery System

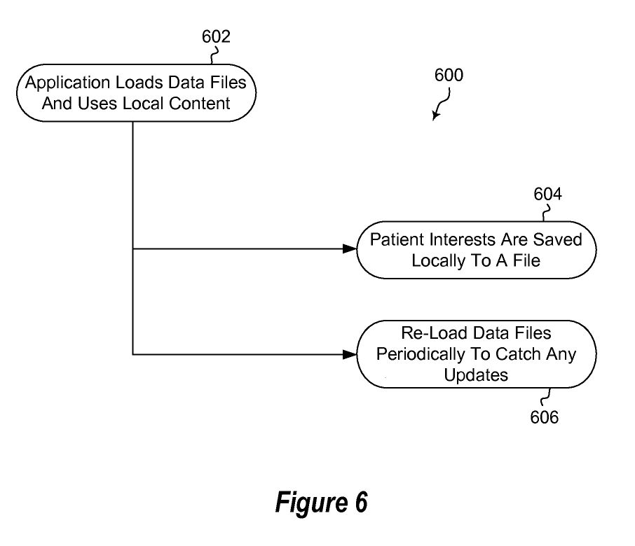

With additional reference to FIGS. 6-10, various example methods of operating the targeted health care content delivery system of FIG. 1, or portions of the targeted health care content delivery system, are disclosed. For instance, FIG. 6 illustrates a method 600 of updating health care content in the local content database 126 of FIG. 1. The method 600 is performed, in some embodiments, by a content selection module 124A operating on a master primary client device 104C.

The method 600 begins at 602 when the content selection module 124A (also referred to herein as the “Application”), loads data files and local content, some or all of which is displayed via a primary client device 104. The data files include user data stored locally and/or read from the database server 108. The local content includes health care content stored locally in the local content database 126. At 604, the content selection module 124A receives and saves patient interests locally to a file in the local content database 126 and/or in other local storage. The patient interests are received via input means of a primary client device 104. At 606, the content selection module 124A re-loads data files periodically to catch any updates to user data.

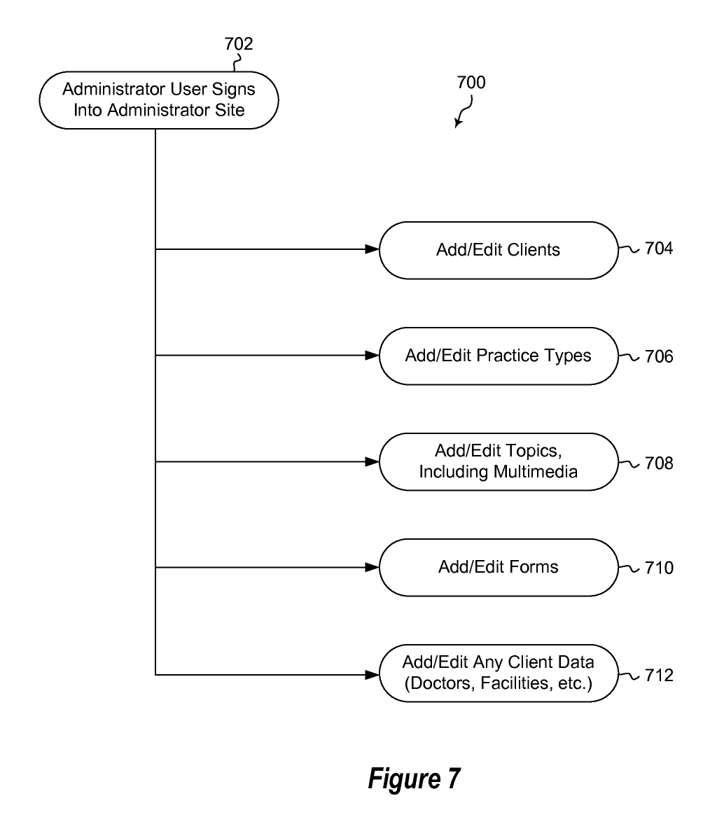

FIG. 7 illustrates a method 700 of updating a content server, such as the content server 106 of FIG. 1, by an administrator user of the targeted health care content delivery system. At 702, an administrator user signs into an administration site hosted by the content server 106. At 704, the content server 106 receives user input adding and/or editing one or more clients. With respect to FIG. 7, “clients” refers to providers that have access to the content server 106. At 706, the content server 106 receives user input adding and/or editing one or more practice types of content available from the content server 106. At 708, the content server 106 receives user input adding and/or editing one or more topic menus, sub-menus, and/or content to a corresponding application map. At 710, the content server 106 receives user input adding and/or editing one or more electronic forms. At 712, the content server 106 receives user input adding and/or editing any client data.

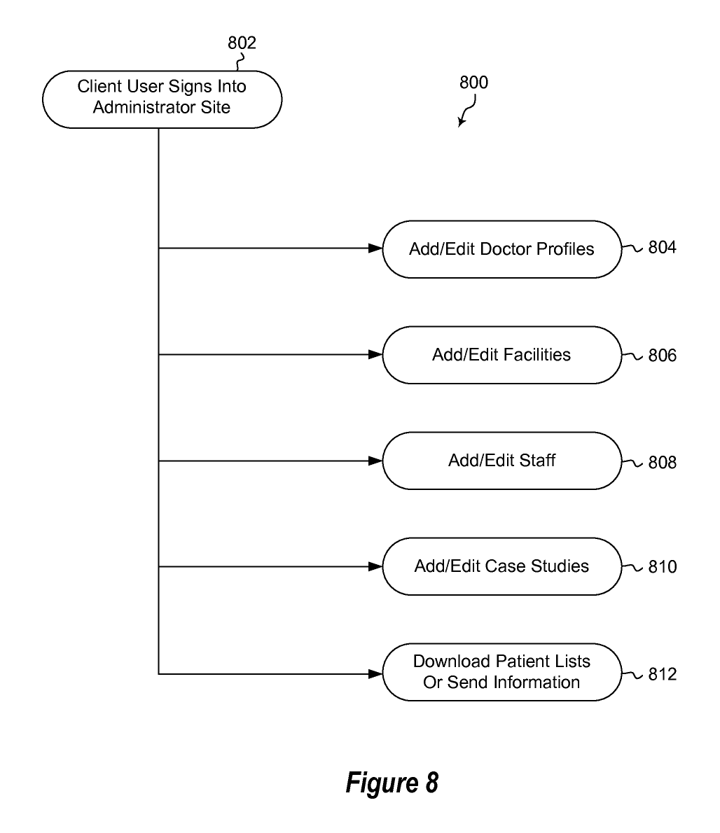

FIG. 8 illustrates a method 800 of updating a content server, such as the content server 106 of FIG. 1, by a client user. With respect to FIG. 8, “client user” refers to any provider that has access to the content server 106 and extends to administrator(s) of the provider's practice or other employee(s) of the provider. At 802, a client user/provider signs into a provider administration site via a primary client device 104, the provider administration site being hosted by the content server 106. At 804, the primary client device 104 receives user input adding and/or editing a profile of the client user/provider. At 806, the primary client device 104 receives user input adding and/or editing facilities. At 808, the primary client device 104 receives user input adding and/or editing staff of the client user/provider and/or access privileges of the staff. At 810, the primary client device 104 receives user input adding and/or editing case studies. At 812, the primary client device 104 downloads patient lists from the content server 106 and/or transmits data indicative of the user input received in steps 804-810 to the content server 106.

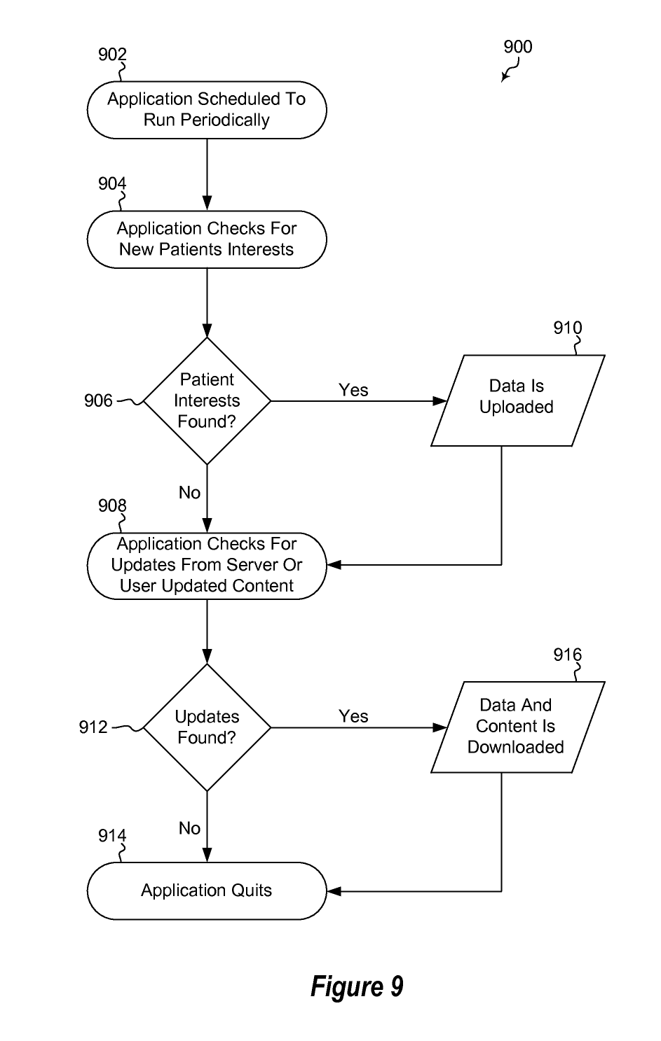

FIG. 9 illustrates a method 900 of syncing a local content database 126 with a remote content database 114 and/or the database server 108. In some embodiments, the method 900 is performed by a content selection module 124A on a master primary client device 104C or more generally by a corresponding content selection module on each of the primary client devices 104. The method 900 begins at 902 with the content selection module 124A (also referred to herein as the “Application”) initializing on the master primary client device 104C. The content selection module 124A can initialize automatically at periodic intervals and/or in response to manual initialization. At 904, the content selection module 124A checks the local content database 126 or other local storage for any patient interests or other user data not previously uploaded to the remote content database 114 and/or database server 108.

At decision step 906, if no patient interests are found, the method 900 proceeds directly to step 908, where the content selection module 124A requests content updates from the content server 106. The content updates generally include new digital content stored in the remote content database 114 by an administrator of the targeted health care content delivery system and/or by another provider. Alternately, if patient interests are found at decision step 906, prior to proceeding to step 908, the method 900 proceeds to step 910 where the patient interests are uploaded to the content server 106 for storage in the remote content database 114 and/or in the database server 108.

At decision step 912, if no content updates are found, the method 900 proceeds directly to step 914, where the content selection module 124A quits. Alternately, if content updates are found at decision step 912, prior to proceeding to step 914, the method 900 proceeds to step 916 where the content updates are downloaded to the primary client device 104C.

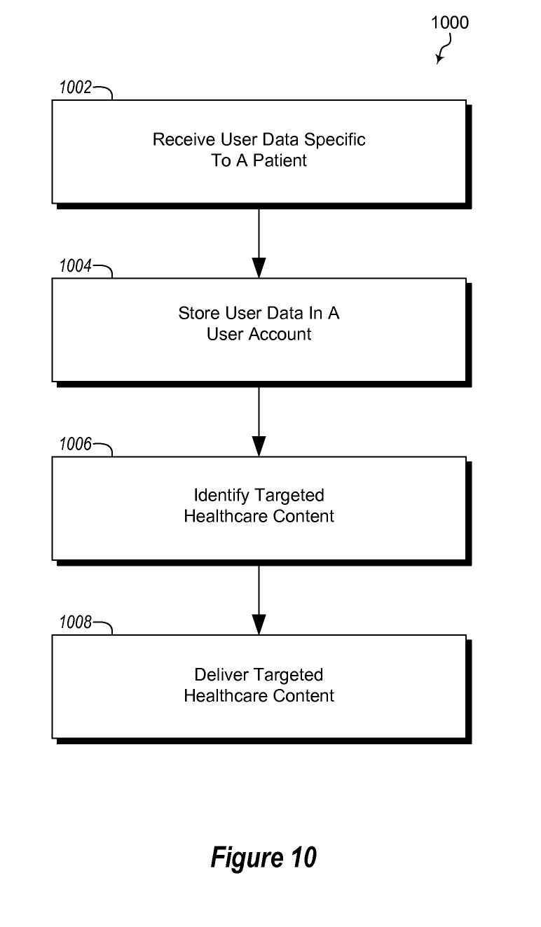

FIG. 10 illustrates a method 1000 of providing targeted content to a patient. In some embodiments, the method 1000 is performed by a content selection module 124A on master primary client device 104C and/or by a content selection module 124B on content server 106. At 1002, the content selection module 124A, 124B receives user data specific to a patient. In some embodiments, the user data is received 1002 after being input by a provider via a primary client device 104. At 1004, the content selection module 124A, 124B stores the user data in a user account associated with the patient. Storing 1004 the user data in a user account associated with the patient includes, in some examples, writing the user data to the database server 108 and/or sending a write request to a content server 106 to write the user data to the database server 108.

At 1006, the content selection module 124A, 124B identifies targeted health care content in a local content database 126 and/or in a remote content database 114 based on some or all of the user data. In some embodiments, the content selection module 124A, 124B employs one or more of the charting module 202, targeting module 204, content sharing module 206, patient authorization module 210 or notification module 212 to identify 1006 the targeted health care content in the local content database 126 and/or in the remote content database 114.

At 1008, the content selection module 124A, 124B delivers the identified targeted health care content to the patient. In the example of the content selection module 124B, delivering 1008 the identified targeted health care content to the patient includes transmitting the identified targeted health care content to a corresponding primary client device 104 for display to the patient. Alternately or additionally, in the example of the content selection module 124A, delivering 1008 the identified targeted health care content to the patient may include transmitting the identified targeted health care content from the master primary client device 104C to a corresponding one of slave primary client devices 104D, 104E. Alternately or additionally, delivering 1008 the identified targeted health care content to the patient includes one or more of: (1) the content selection module 124A, 124B cooperating with a corresponding one of primary client devices 104 to display the identified targeted health care content to the patient, including displaying the identified targeted health care content visually and/or audibly, or (2) the content selection module 124A, 124B transmitting an electronic message to the patient, the electronic message comprising the identified targeted health care content or a link to the identified targeted health care content.

It will be appreciated by those of skill in the art that the example methods 600, 700, 800, 900, 1000 described above are provided by way of illustration and not by way of limitation and that process steps and/or actions can be rearranged in order and combined or eliminated and that other actions may be added due to design considerations depending on the implementation of the targeted health care content delivery system. Further, although the embodiments of FIGS. 1-10 have been explained in the context of digital health care content, embodiments of the invention are equally applied to the storage, selection, and/or targeted delivery of digital content other than digital health care content.

Some embodiments of the invention allow a provider to provide patients with targeted and/or generic information in an electronic format that the patient can access during a visit to the provider and/or at a later time to review or share the information with others. Alternately or additionally, embodiments of the invention provide targeted information to patients to educate the patient such that the patient has an idea of relevant questions to ask a provider. Alternately or additionally, embodiments of the invention substantially reduce and/or eliminate the frustration associated with wait times commonly experienced during medical visits by providing the patient with targeted information during the wait time and creating a perception that the provider is attuned to the particular needs of the patient. Alternately or additionally, embodiments of the invention create the perception that the provider is using the latest technology. Alternately or additionally, embodiments of the invention reduce and/or eliminate time required to create charts for patients. In summary, some embodiments of the invention provide an interactive and engaging service that can be used to, among other things, welcome patients, enhance relationships between patients and providers, educate patients, increase the efficiency/productivity of the provider and/or decrease wait time.

### V. Computing Environment

Aspects of the targeted health care content delivery system can be implemented in a distributed computing network using a master-client architecture and/or a software-as-a-service architecture.

The embodiments described herein may include the use of a special purpose or general purpose computer including various computer hardware and/or software modules, as discussed in greater detail below.

Embodiments within the scope of the present invention may also include physical computer-readable media and/or intangible computer-readable media for carrying or having computer-executable instructions or data structures stored thereon. Such physical computer-readable media and/or intangible computer-readable media can be any available media that can be accessed by a general purpose or special purpose computer. By way of example, and not limitation, such physical computer-readable media can comprise RAM, ROM, EEPROM, CD-ROM or other optical disk storage, magnetic disk storage or other magnetic storage devices, or any other physical medium which can be used to carry or store desired program code means in the form of computer-executable instructions or data structures and which can be accessed by a general purpose or special purpose computer. Within a general purpose or special purpose computer, intangible computer-readable media can include electromagnetic means for conveying a data signal from one part of the computer to another, such as through circuitry residing in the computer.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

Embodiments may also include computer program products for use in the systems of the present invention, the computer program product having a physical computer-readable medium having computer-readable program code stored thereon, the computer-readable program code comprising computer-executable instructions that, when executed by a processor, cause the system to perform the methods of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of providing targeted content to a patient, comprising:
receiving user data specific to a patient;
storing the user data in a user account associated with the patient;
identifying targeted health care content in a content database based on some or all of the user data; and
delivering the targeted health care content to the patient.

2. The method of claim 1, wherein delivering the targeted health care content to the patient includes one or more of:
displaying the targeted health care content to the patient via an electronic display; or
transmitting an electronic message to the patient, the electronic message comprising the targeted health care content or a link to the targeted health care content.

3. The method of claim 2, wherein the targeted health care content is displayed to the patient via an electronic display at a physical facility of a health care provider, the method further comprising hosting the targeted health care content on a website accessible through a browser on a client device associated with the patient.

4. The method of claim 3, wherein the patient logs into the website using a username and password associated with a user account of the patient.

5. The method of claim 3, further comprising providing the patient with access through the website to at least two of: user data associated with the patient, content presented to the patient during a consultation at the physical facility of the health care provider, or the targeted health care content.

6. The method of claim 3, wherein the targeted health care content includes an image of the patient or of an anatomical model, the image including markings added by the health care provider during a consultation with the patient to explain a medical procedure to the patient.

7. The method of claim 3, further comprising generating an alert regarding a procedure or date relating to a health condition of the patient based on user data identifying the health condition of the patient.

8. A method of providing health care content to patients, comprising:
storing, in a database, health care content relating to one or more specific health care practice areas;
tagging the health care content with keywords such that the health care content is pluggable into targeted searching capabilities;
receiving user data specific to a patient, the user data identifying at least one of a medical condition or an interest of the patient;
searching the health care content for targeted health care content targeted to the patient based on the keyword tags relating to the medical condition or the interest of the patient; and
delivering the targeted health care content to the patient.

9. The method of claim 8, wherein delivering the targeted health care content to the patient includes one or more of:
displaying health care content to the patient via an electronic display; or
transmitting an electronic message to the patient, the electronic message comprising the targeted health care content or a link to the targeted health care content.

10. The method of claim 8, wherein the health care content is automatically tagged by parsing the health care content to identify content, metatags, summaries, or other characteristics of the health care content that identify subject matter of the health care content.

11. The method of claim 8, wherein the user data specific to the patient is received from a provider, the method further comprising:
storing marketing content relating to produces or services offered by the provider;
tagging the marketing content with keywords that identify the subject matter of the marketing content;
delivering targeted marketing content to the patient, the targeted marketing content including marketing content tagged with keywords relating to the at least one medical condition and/or at least one interest of the patient.

12. The method of claim 8, further comprising:
storing, in the database, new health care content relating to one or more specific health care practice areas;
notifying the patient when new health care content relating to the at least one medical condition and/or at least one interest of the patient is stored in the database.

13. The method of claim 12, wherein the new health care content is identified as being related to the at least one medical condition and/or at least one interest of the patient by searching keyword tags of the new health care content

14. The method of claim 8, further comprising:
identifying, based on the received user data, an electronic form for the patient to sign;
retrieving the electronic form from a storage medium;
displaying the electronic form to the patient; and
capturing authentication data indicative of the patient's execution of the electronic form.

15. The method of claim 14, wherein the executed electronic form expresses the patient's consent to a particular medical procedure or the patient's consent for a first provider to share the patient's medical records with a second provider.

16. The method of claim 14, wherein the authentication data includes an electronically captured patient signature, an image of the patient while signing the patient's name, or both the electronically captured patient signature and the image of the patient while signing the patient's name.

17. A targeted health care content delivery system, comprising:
a computing device in a distributed network computer system for executing computer-executable instructions;
a content database configured to store health care content relating to one or more specific health care practice areas; and
a content selection module comprising computer-executable instructions stored on a physical computer readable medium located in a distributed network computer system that when executed by the computing device identifies targeted health care content in the content database based on user data associated with a patient and delivers the targeted health care content to the patient.

18. The targeted health care content delivery system of claim 17, wherein the content selection module includes a targeting module comprising computer-executable instructions stored on a physical computer readable medium located in the distributed network computer system that when executed by the computing device identifies targeted health care content for delivery to the patient based on the user data, the content selection module further comprising one or more of:
a charting module comprising computer-executable instructions stored on a physical computer readable medium located in the distributed network computer system that when executed by the computing device generates one or more charts graphically representing one or more quantifiable health indicators of the patient and a corresponding norm;
a content sharing module comprising computer-executable instructions stored on a physical computer readable medium located in the distributed network computer system that when executed by the computing device facilitates sharing between different providers of medical records collected by the providers;
a patient access module comprising computer-executable instructions stored on a physical computer readable medium located in the distributed network computer system that when executed by the computing device allows the patient to remotely access health care content;
a patient authorization module comprising computer-executable instructions stored on a physical computer readable medium located in the distributed network computer system that when executed by the computing device generates forms electronically signed by the patient;
a notification module comprising computer-executable instructions stored on a physical computer readable medium located in the distributed network computer system that when executed by the computing device delivers to the patient new digital content added to the content database;
a marketing module comprising computer-executable instructions stored on a physical computer readable medium located in the distributed network computer system that when executed by the computing device delivers marketing content to the patient; or
a system alert module comprising computer-executable instructions stored on a physical computer readable medium located in the distributed network computer system that when executed by the computing device generates an alert regarding a procedure, date, or both, relating to a health condition of the patient.

19. The system of claim 18, further comprising a touch screen unit configured to electronically capture a patient signature as input for the patient authorization module.

20. The system of claim 18, wherein the content selection module comprises at least the targeting module and the charting module and the corresponding norm is based on user data associated with the patient including an identification of a medical condition of the patient
